(19) United States
(12) Patent Application Publication
(10) Pub. No.: US 2012/0006645 A1
(43) Pub. Date: Jan. 12, 2012

(54) CLUTCH COVER ASSEMBLY

(75) Inventors: Takeshi Hayashi, Osaka (JP); Takashi Harada, Osaka (JP)

(73) Assignee: EXEDY CORPORATION, Neyagawa-shi, Osaka (JP)

(21) Appl. No.: 13/257,064

(22) PCT Filed: Mar. 15, 2010
(86) PCT No.: PCT/JP2010/054290

§ 371 Date: Sep. 16, 2011

(30) Foreign Application Priority Data
Apr. 3, 2009 (JP) 2009-091444

(51) Int. Cl. F16D 13/71

(52) U.S. Cl. 192/89.23

(57) ABSTRACT

The clutch cover assembly includes a clutch cover, a pressure plate, and a diaphragm spring. The pressure plate is arranged to rotate as an integral unit with the clutch cover and move in an axial direction with respect to the clutch cover, and to press a friction member toward a flywheel. The diaphragm spring is supported on the clutch cover and serves to apply a force against the pressure plate toward the flywheel. The clutch cover has an annular clutch cover body and a plurality of plate-like support sections that are provided on an inner circumferential portion of the clutch cover body and serve to support the diaphragm spring such that the diaphragm spring can undergo elastic deformation. The support sections are configured such that a dimension of a tip end of the support section tapers gradually to a smaller dimension in a circumferential direction.

### TECHNICAL FIELD

The present invention relates to a clutch cover assembly, particularly a clutch cover assembly contrived to press a friction member of a clutch disk assembly against a flywheel of an engine and to release the friction member from the flywheel.

### BACKGROUND ART

A clutch cover assembly is typically attached to a flywheel of an engine and used to transmit a drive force from the engine toward a transmission. Such a clutch cover assembly comprises chiefly a clutch cover fixed to the flywheel, a pressure plate that can push a friction member of a clutch disk assembly against the flywheel, and a diaphragm spring for pressing the pressure plate toward the flywheel. The diaphragm spring comprises an annular elastic section and a plurality of lever sections that extend radially inward from an internal edge of the annular elastic section. In addition to the function of pressing the pressure plate, the diaphragm spring also has a lever function for releasing the pressure applied to the pressure plate (e.g., see Patent Document 1).

[Citation List]

[Patent Literature]

[Patent Literature 1] Japanese Laid-open Patent Publication No. 3-22131

### SUMMARY OF THE INVENTION

In a conventional clutch cover assembly, the clutch cover has an annular clutch cover body and a plurality of support sections that are provided on an inner circumferential portion of the clutch cover body and serve to support the diaphragm spring such that the diaphragm spring can undergo elastic deformation. The support sections comprise plate-like protrusions that protrude radially inward from the clutch cover body and have been bent inward. For example, the diaphragm spring and two wire rings functioning as a fulcrum when the diaphragm spring undergoes elastic deformation are sandwiched in-between the clutch cover body and the support sections. With this arrangement, the attitude of the diaphragm spring can be changed about a fulcrum located near where the diaphragm spring contacts the wire rings.

Since the support sections are formed by bending portions of the clutch cover, the structure can be simplified and the manufacturing cost can be reduced.

However, since the support sections protrude from the clutch cover body toward the flywheel, there is a possibility that the support sections will interfere with other parts in some cases.

Meanwhile, if a large space is provided in a region surrounding the support sections in order to prevent the support sections from interfering with other parts, then the clutch cover assembly will tend to be larger in size.

An object of the present invention is to provide a clutch cover assembly that can achieve a reduced manufacturing cost while also preventing the size from becoming large.

A clutch cover assembly according to the present invention is an apparatus for pressing a friction member of a clutch disk assembly against a flywheel of an engine and for releasing the friction member from the flywheel. This clutch cover assembly comprises a clutch cover, a pressure plate, and a diaphragm spring. The clutch cover is fixed to the flywheel. The pressure plate is arranged such that it can rotate as an integral unit with the clutch cover and move in an axial direction with respect to the clutch cover and contrived such that it can press the friction member against the flywheel. The diaphragm spring is supported on the clutch cover and serves to apply a force against the pressure plate toward the flywheel. The clutch cover has an annular clutch cover body that is fixed to the flywheel and a plurality of support sections that are provided on an inner circumferential portion of the clutch cover body and serve to support the diaphragm spring such that the diaphragm spring can undergo elastic deformation. The support sections are configured such that a tip end of each of the support sections tapers gradually to a smaller dimension in a circumferential direction.

With this clutch cover assembly, the size can be prevented from becoming large because the circumferential dimension of the tip ends of the support sections tapers gradually to a smaller dimension such that the space occupied by the support sections can be reduced. Additionally, since the support members are plate-like, the structure can be simplified and the manufacturing cost can be reduced.

### BRIEF DESCRIPTION OF DRAWINGS

FIG. 1 is a plan view of a clutch cover assembly.

FIG. 2 is a cross sectional view taken along II-II of FIG. 1.

FIG. 3 is a partial cross sectional view of a clutch cover assembly.

FIG. 4 is a development of a support section.

FIG. 5 is a cross sectional view taken along V-V of FIG. 3.

FIG. 6 is a development view of a support section (another embodiment).

FIG. 7 is a development view of a support section (another embodiment).

### DESCRIPTION OF EMBODIMENTS

<Overall Structure of Clutch Cover Assembly>

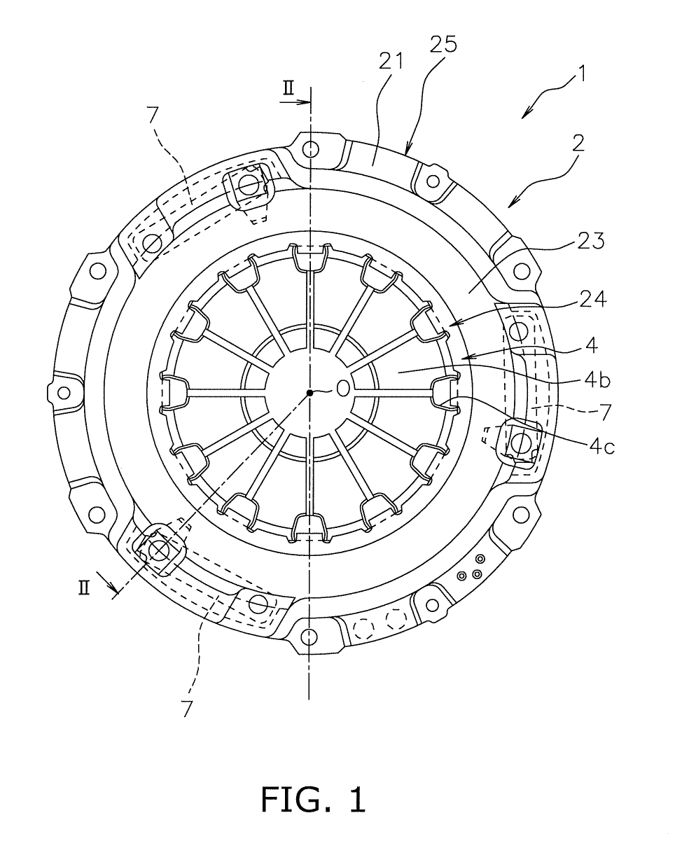

The clutch cover assembly 1 shown in FIGS. 1 to 3 is a device for engaging a clutch by pressing a friction member 53 of a clutch disk assembly (not shown) against a flywheel 51 of an engine and for disengaging the clutch by releasing the friction member 53 from the flywheel 51. The clutch cover assembly 1 is a push-type clutch cover assembly.

A line O-O shown in FIGS. 1 to 3 indicates a rotational axis of the flywheel 51 and the clutch cover assembly 1. In the following explanations, the axially leftward side in FIGS. 1 to 3 is called an engine side and the axially rightward side is called a transmission side.

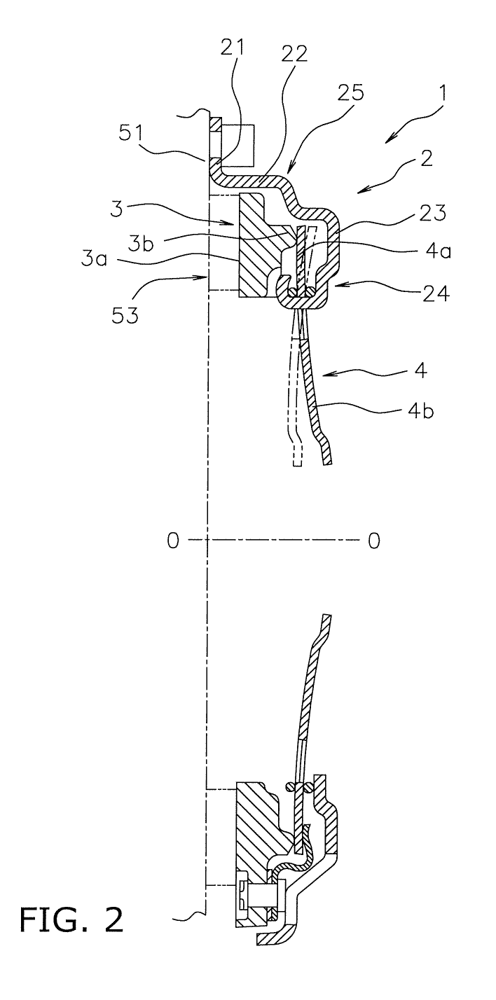

As shown in FIGS. 1 and 2, the clutch cover assembly 1 comprises chiefly a clutch cover 2, a pressure plate 3, and a diaphragm spring 4.

### Clutch Cover

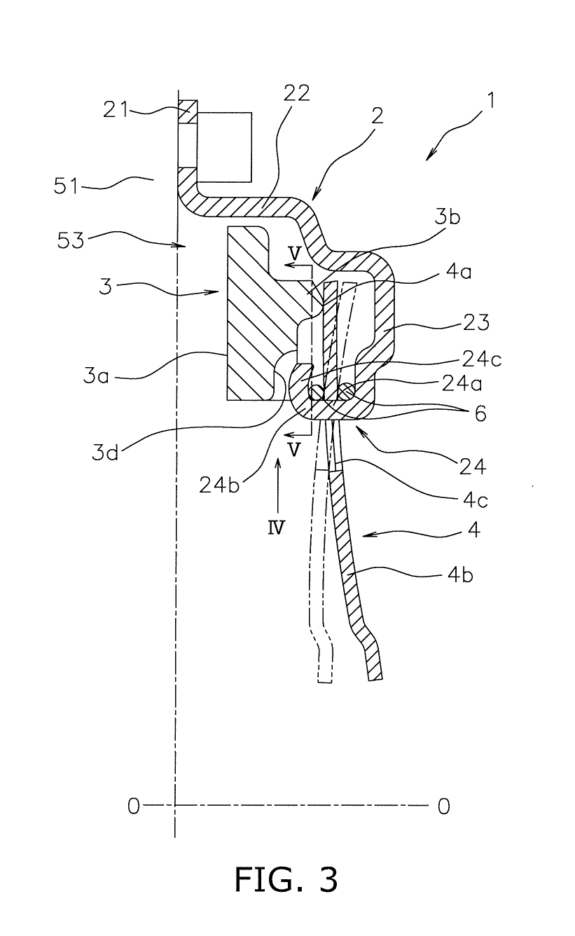

As shown in FIG. 3, the clutch cover 2 is a plate member having a generally saucer-like shape and is fastened to the flywheel 51 with, for example, bolts installed through an outer circumferential portion of the clutch cover 2. More specifically, the clutch cover 2 has a clutch cover body 25 and a plurality of support sections 24 formed as integral parts of the clutch cover body 25.

(1) Clutch Cover Body

As shown in FIG. 3, the clutch cover body 25 is an annular portion having a fastening section 21, an outer circumferential section 22, and an annular section 23. The fastening section 21 is a portion that is fastened to the flywheel 51. The outer circumferential portion 22 is a generally cylindrical portion that extends in an axial direction from the fastening section 21. The annular section 23 is an annular portion extending radially inward from the outer circumferential section 22 and configured such that an inner circumferential portion is recessed toward the flywheel 51.

(2) Support Section

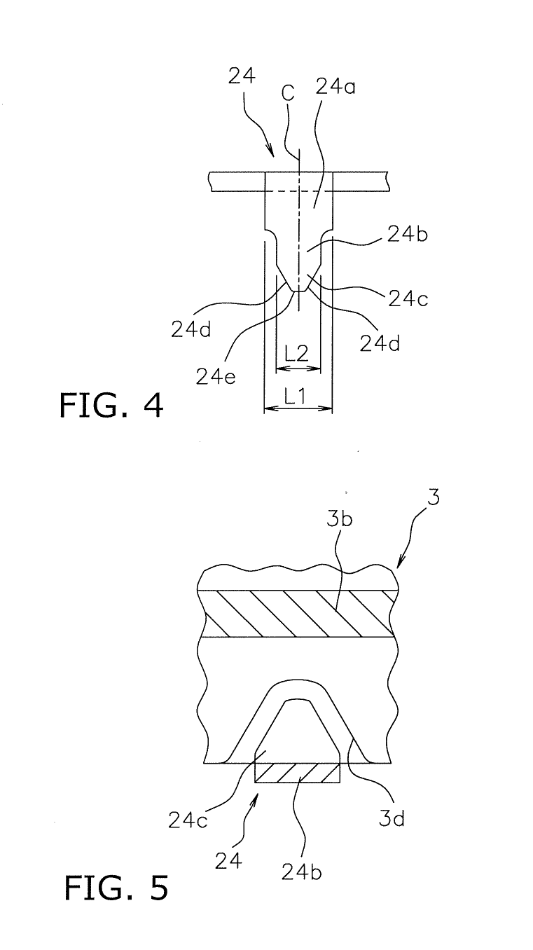

The support sections 24 are arranged on an inner circumferential portion of the clutch cover body 25 (inner circumferential portion of the annular section 23) and serve to support the diaphragm spring 4 on the clutch cover assembly 25 such that the diaphragm spring 4 can undergo elastic deformation. More specifically, as shown in FIGS. 3 and 4, the support sections 24 are bent inward (toward the flywheel 51) from an inner circumferential portion of the clutch cover body 25 and each has a first portion 24a, a second portion 24b, and a third portion 24c. FIG. 4 is a development view of a support section 24 before the second portion 24b is bent.

The first portion 24a protrudes axially toward the engine from an inner circumferential edge of the annular section 23 and is inserted through a hole 4c (explained later) of the diaphragm spring 4.

The second portion 24b is curved from an end portion of the first portion 24a as shown in FIG. 3 such that it extends toward the engine and radially outward. As shown in FIG. 4, a width L2 (example of a circumferential dimension) of the second portion 24b is set to be smaller than a width L1 (example of a circumferential dimension) of the first portion 24a.

The second portion 24b curves toward a radially outward direction and touches against one wire ring 6. Another wire ring 6 touches against the annular section 23. The two wire rings 6 and the diaphragm spring 4 are sandwiched between the annular section 23 and the second portion 24b.

The third portion 24c is a portion that protrudes in a radially outward direction from an end portion of the second portion 24b and has a portion with a smaller width than the second portion 24b. More specifically, as shown in FIG. 4, the third portion 24c has a pair of diagonal surfaces 24d that are diagonal with respect to a radial direction. The width of the third portion 24c tapers gradually to a smaller width than the second portion 24b. The diagonal surface 24d are arranged in a linearly symmetrical manner with respect to a centerline C of the first portion 24a and the second portion 24b. Since the centerline C is parallel with respect to a circumferential direction, the diagonal surface 24d can be said to be diagonal with respect to the centerline C. Since the first portion 24a, the second portion 24b, and the third portion 24c share a common center along a circumferential direction, the centerline C is a centerline dividing both the first portion 24a and the third portion 24c in half with respect to a circumferential direction.

Also, an end surface 24e joins the diagonal surfaces 24d together at the tip end of the third portion 24c. The end surface 24e is perpendicular to the centerline C. Due to the diagonal surfaces 24d, a width of a tip end portion of the support section 24 gradually tapers to a smaller width as one moves in a radially outward direction along the support section 24.

### Pressure Plate

The pressure plate 3 is an annular member having a pressing surface 3a formed on a side that faces toward the flywheel 51. The friction member 53 of the clutch disk assembly is arranged between the pressing surface 3a and the flywheel 51. A generally annular protrusion 3b that protrudes in an axial direction is provided on the opposite side of the pressure plate 3 as the side where the pressing surface 3a is located. The pressure plate 3 is connected to the clutch cover 2 with a plurality of strap plates 7 (FIG. 1) such that the pressure plate 3 can rotate as an integral unit with the clutch cover 2 but cannot move in an axial direction relative to the clutch cover 2.

As shown in FIG. 3 and FIG. 5 (which is a view along the direction of the arrows V-V in FIG. 3), a plurality of recessed sections 3d configured be depressed in an axial direction toward the engine are formed in an inner circumferential portion of the pressure plate 3. The third portions 24c of the support section 24 are arranged inside the recessed portions 3d. As shown in FIG. 5, the recessed portions 3d are configured to be a size larger than the third portions 24c.

### Diaphragm Spring

The diaphragm spring 4 is a circular disk-shaped member that is arranged between the pressure plate 3 and the clutch cover 2 and supported by the clutch cover 2 such that it can undergo elastic deformation. More specifically, the diaphragm spring 4 has an annular elastic section 4a and a plurality of lever sections 4b that extend radially inward from an inner circumferential portion of the annular elastic section 4a. The annular elastic section 4a touches against the protrusion 3b of the pressure palate 3 when the clutch is engaged. A plurality of slits are formed between the lever sections 4b and a plurality of holes 4c are formed at radially outward ends of the slits.

The first portions 24a of the support sections 24 are inserted through the holes 4c. The two wire rings 6 are arranged both axially opposite sides of the diaphragm spring 4 and the two wire rings 6 and the diaphragm spring 4 are sandwiched between the support sections 24 and the annular section 23. More specifically, the wire rings 6 and an inner circumferential portion of the annular elastic section 4a are sandwiched between the second portions 24b of the support sections 24 and an inner circumferential portion of the second portion 24b. The second portion 24b and an inner circumferential portion of the annular section 23 each contact one of the wire rings 6.

Also, a push-type release device (not shown) is arranged contacting the tip ends of the lever sections 4b of the diaphragm spring 4. To release the clutch, the release device pushes the end portions of the lever sections 4b of the release device toward the engine and releases a pushing force the diaphragm spring 4 is exerting against the pressure plate 3.

### Operation

When the release device is not exerting a load against the tip ends of the lever sections 4b of the diaphragm spring 4, the pressure plate 3 is pushed toward the engine relative to the clutch cover 2 by the annular elastic section 4a. As a result, the friction member 53 of the clutch disk assembly is pressed against the flywheel 51 and a torque is transmitted to the clutch disk assembly (clutch in connected state).

When the release device pushes the tip ends of the lever sections 4b of the diaphragm spring 4 toward the engine, an outer circumferential portion of the annular elastic section 4a of the diaphragm spring 4 is lifted in an axial direction toward the transmission about a fulcrum located at a contacting portion between the wire rings 6 and the diaphragm spring 4. As a result, the annular elastic section 4a no longer pushes the pressure plate 3 and, the pressure plate 3 separates from the friction member 53 due to the elastic forces of the strap plates 7, and finally the friction member 53 separates from the flywheel 51 (clutch in released state).

### Distinctive Features

During the release operation, an attitude of the diaphragm spring 4 with respect to the clutch cover 2 changes about a fulcrum located at a portion where the diaphragm spring 4 contacts the wire rings 6. Consequently, a portion of the clutch cover 2 that contacts the wire rings 6 is pressed by the wire rings 6 and could easily become worn.

However, with this clutch cover assembly 1, since the width of the second portions 24b of the support sections 24 are set to be comparatively wide, the surface pressure at the portions where the wire rings 6 contact the second portions 24b can be held comparatively low and wear of the clutch cover 2 can be suppressed.

Since the width of the tip ends of the support sections 24 (third portions 24c) tapers gradually to a smaller width, the amount of space occupied by the support sections 24 can be reduced and the clutch cover assembly can be prevented from becoming large in size. Furthermore, since the support sections 24 are plate-like, the structure can be simplified and the manufacturing cost can be reduced.

Since the third portions 24c of the support section 24 are arranged inside the recessed sections 3d of the pressure plate 3, the pressure plate 3 can be arranged closer to the clutch cover 2 in an axial direction and the axial dimension of the entire clutch cover assembly 1 can be shortened.

Since the third portions 24c have diagonal surfaces 24d, the size of the tip ends of the support sections 24 can be held small even though the width of the second portions 24b is large. Thus, the support sections 24 can be configured to fit inside the recessed sections 3d of the pressure plate 3 even if the width of the support sections 24 is set to be large. As a result, the same pressure plate 3 can be used with clutch covers 2 having different design specifications and productivity can be increased.

### Other Embodiments

The present invention is not limited to the embodiment explained above and variations can be made without departing from the scope of the invention. Parts that have substantially the same function as the parts of the previously explained embodiment are assigned the same reference numerals as in the previously explained embodiment and detailed explanations thereof are omitted.

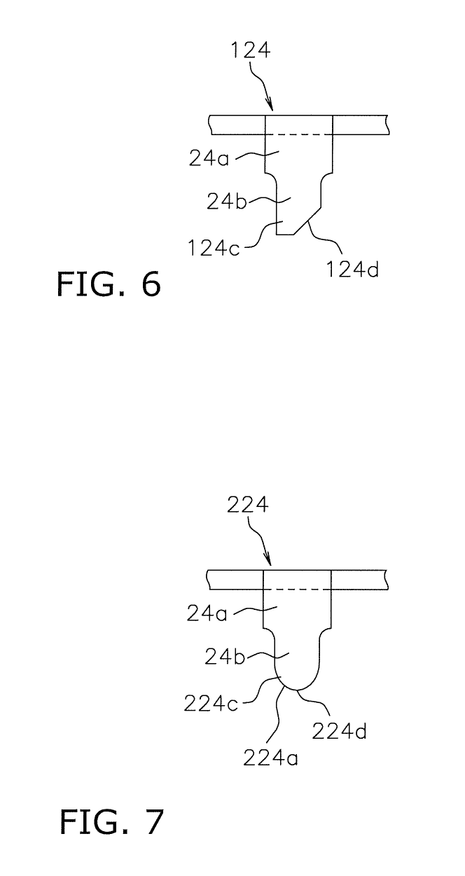

Although the previously explained third portion 24c has a pair of diagonal surfaces 24d, it is acceptable to configure a support section 124 such that the third section 124c has one diagonal surface 124d instead of a pair of diagonal surfaces 24d, as shown in FIG. 6. It is also acceptable to configure a support section 224 to have a pair of curved surfaces 224d instead of a pair of planar diagonal surfaces 24d, as shown in FIG. 7. In short, the previously explained effects can be obtained with any shape so long as the width of the third portion 24c tapers to a smaller width.

### INDUSTRIAL APPLICABILITY

The a clutch cover assembly according to the present invention is applicable to a power transmitting apparatus for a vehicle because it enables a manufacturing cost to be suppressed while keeping the size of the clutch cover assembly in check.

### REFERENCE SIGNS LIST

1 clutch cover assembly
2 clutch cover
21 fastening section
22 outer circumferential section
23 annular section
24 support section
24a first portion
24b second portion
24c third portion
24d diagonal surface
24e end surface
25 clutch cover body
3 pressure plate
3d recessed section
4 diaphragm spring
6 wire ring

1. A clutch cover assembly for pressing a friction member of a clutch disk assembly against a flywheel of an engine and for releasing the friction member from the flywheel, the clutch cover assembly comprising:
a clutch cover being fixedly configure to the flywheel;
a pressure plate being arranged to be integrally rotatable with the clutch cover, the pressure plate being movable in an axial direction with respect to the clutch cover, the pressure plate being configured to press the friction member against the flywheel; and
a diaphragm spring supported by the clutch cover and configured to urge the pressure plate toward the flywheel, the diaphragm spring including first and second longitudinal ends,
the clutch cover including an annular clutch cover body fixed to the flywheel and a plate-like support section being arranged on an inner circumferential portion of the clutch cover body, the clutch cover support section supporting the diaphragm spring at a part between the first and second ends
the support section tapers in a circumferential direction.

2. The clutch cover assembly of claim 1, wherein
the support section includes
a first portion protruding from the inner circumferential portion of the clutch cover body toward the clutch disk assembly,
a second portion extending in a radially outward direction from an end portion of the first portion, and
a third portion being a tip end of the support section,
the second portion supports the diaphragm spring together with the clutch cover body,
a size of the second portion is smaller than a size of the first portion, and
the third portion is arranged on an end portion of the second portion and is configured to taper in the circumferential direction.

3. The clutch cover assembly of claim 2, wherein
the third portion has at least one diagonal surface that is diagonal with respect to a radial direction.

4. The clutch cover assembly recited in claim 2, wherein
the pressure plate includes a recessed section arranged in the inner circumferential portion
the recessed section has depth in the axial direction, and
the tip end of the support section is configured inside the recessed section.
